(19) United States
(12) Patent Application Publication
(10) Pub. No.: US 2012/0116883 A1
(43) Pub. Date: May 10, 2012

(54) METHODS AND SYSTEMS FOR USE IN INCORPORATING TARGETED ADVERTISING INTO MULTIMEDIA CONTENT STREAMS

(75) Inventors: Aravind Asam, San Diego, CA (US); Tanmay Agnihotri, San Diego, CA (US)

(73) Assignee: SONY CORPORATION, Tokyo (JP)

(21) Appl. No.: 13/098,289

(22) Filed: Apr. 29, 2011

Related U.S. Application Data
(60) Provisional application No. 61/411,088, filed on Nov. 8, 2010.

(51) Int. Cl. G06Q 30/00

(52) U.S. Cl. 705/14.58; 705/14.73; 705/14.49

(57) ABSTRACT

Some embodiments provide methods, systems and apparatuses for use in distributing multimedia content. Some of these methods comprise: receiving a substantially live media stream comprising visual multimedia content and a playlist file that defines the playback of the visual multimedia content; identifying, within the media stream, a first advertisement content; identifying a source location identifier corresponding to a segment of the first advertisement content; identifying a replacement advertisement content; identifying a source location identifier corresponding to a segment of the replacement advertisement content; modifying the playlist file replacing the source location identifier corresponding to the segment of the first advertisement content with the source location identifier corresponding to the segment of the replacement advertisement content; and communicating, in substantially real time, the modified playlist file over the Internet to a remote CE device.

This application claims the benefit of U.S. Provisional Application No. 61/411,088, filed Nov. 10, 2010, for Asam et al., entitled IPTV LIVE STREAMING WITH TARGETED AD, which is incorporated in its entirety herein by reference.

### BACKGROUND

1. Field of the Invention

The present invention relates generally to the distribution of content, and more specifically to the distribution of multimedia content.

2. Discussion of the Related Art

The distribution of information and content has dramatically increased. Many devices have been configured to take advantage of this increased distribution. In some instances, devices are configured to distribute content to remote sources that can play back the content. Further, the content in some instances may be distributed over networks, such as the Internet.

### SUMMARY OF THE INVENTION

Several embodiments of the invention advantageously provide methods and systems for use in distributing multimedia content to be played back at consumer electronic (CE) devices. Some of these methods comprise: receiving, at a distribution service accessible by CE devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back; identifying, within the media stream, a first advertisement content; identifying, within the playlist file, one or more source location identifiers corresponding to one or more segments of the first advertisement content; identifying a first replacement advertisement content to replace the first advertisement content; identifying one or more source location identifiers corresponding to one or more segments of the first replacement advertisement content; modifying in substantially real time the playlist file, the modifying comprising replacing each of the one or more source location identifiers corresponding to the segments of the first advertisement content defined within the media stream with the one or more source location identifiers corresponding to the one or more segments of the first replacement advertisement content producing a modified playlist file; and communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

Other embodiments can be characterized as providing a computer program product comprising a medium for embodying a computer program for input to a processor based system and a computer program embodied in the medium configured to cause the processor based system to perform steps comprising: receiving, at a distribution service accessible by CE devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back; identifying, within the media stream, a first advertisement content; identifying, within the playlist file, one or more source location identifiers corresponding to one or more segments of the first advertisement content; identifying a first replacement advertisement content to replace the first advertisement content; identifying one or more source location identifiers corresponding to one or more segments of the first replacement advertisement content; modifying in substantially real time the playlist file, the modifying comprising replacing each of the one or more source location identifiers corresponding to the segments of the first advertisement content defined within the media stream with the one or more source location identifiers corresponding to the one or more segments of the first replacement advertisement content producing a modified playlist file; and communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

Additionally some embodiments provide systems for use in distributing multimedia content. Some of these systems comprise: means for receiving, at a distribution service accessible by CE devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back; means for identifying, within the media stream, a first advertisement content; means for identifying, within the playlist file, one or more source location identifiers corresponding to one or more segments of the first advertisement content; means for identifying a first replacement advertisement content to replace the first advertisement content; means for identifying one or more source location identifiers corresponding to one or more segments of the first replacement advertisement content; means for modifying in substantially real time the playlist file by replacing each of the one or more source location identifiers corresponding to the segments of the first advertisement content defined within the media stream with the one or more source location identifiers corresponding to the one or more segments of the first replacement advertisement content producing a modified playlist file; and means for communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts a simplified flow diagram of a process of distributing multimedia content according to some embodiments.

FIG. 2 depicts a simplified block diagram representation of a distribution of modified playlist files to a plurality of consumer electronic (CE) devices.

FIG. 3 depicts a simplified flow diagram of a process of selecting replacement content according to some embodiments.

FIG. 4 depicts a simplified block diagram of a system configured to provide the distribution of modified playlist files to be used at CE devices in acquiring and playing back multimedia content according to some embodiments.

FIG. 5 illustrates a system for use in implementing methods, techniques, devices, apparatuses, systems, services, servers, sources and the like in distributing content, modifying playlist files and/or using the modified playlist files in accessing and playing back content in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations,” or similar language means that a particular feature, structure, or characteristic described in connection with the embodiment is included in at least one embodiment of the present invention. Thus, appearances of the phrases “in some embodiment,” “in some implementations,” and similar language throughout this specification may, but do not necessarily, all refer to the same embodiment.

The present embodiments provide methods and systems for use in distributing multimedia content with advertisements that are more relevant to a user over a distributed network, such as the Internet, to network enabled consumer electronic (CE) devices or other such devices. Further, many embodiments provide for the distribution of live multimedia content where at least some of the advertisement content from the live media stream is identified and replaced with more relevant advertisement content. In many implementations the replacement of advertisement content occurs in real time.

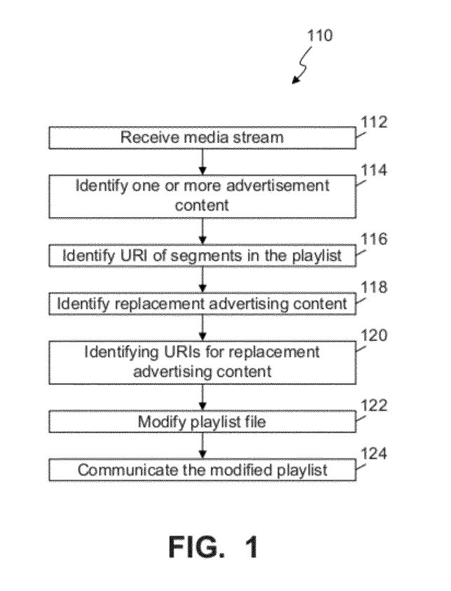

FIG. 1 depicts a simplified flow diagram of a process 110 of distributing multimedia content according to some embodiments. In step 112, the media stream is received at a distribution service or server. Typically, the media stream comprises audio/video and/or visual multimedia content and a playlist or index file defining the playback of the multimedia content. In some instances, the media stream may include additional information such as metadata, headers, error correction and the like. The multimedia content is typically segmented into a plurality of segments, and in some instances the segments have substantially the same playback duration or length.

The segments include primary or main program content segments of the program to be watched (e.g., segments of a sporting event or other entertainment event captures via a video camera), and advertisement segments of advertisement content. An advertisement content can be contained in a single segment, one or more segments can be used for a single advertisement content, or multiple different advertisement content can be included in one segment. The advertisement segments can be positioned substantially anywhere within the media stream. For example, the advertisement segments can be interspersed within the main program segments, be grouped, be grouped at a beginning or an end, or other such positioning or combination of such positioning. Similarly, multiple advertisements may be grouped, with groups of advertisements dispersed within the main program segments. Additionally, the main program segments are not limited to a single program or event. In some instances, the main program segments may comprise a first set of main program segments for a first main program followed by one or more subsequent sets of main program segments for one or more subsequent main programs. The one or more main programs can be live content, such as video of a live sporting or entertainment event, or prerecorded content.

The playlist file of the media stream comprises source location identifiers and/or information that are configured to be used by a receiving playback device (e.g., a receiving consumer electronic (CE) device) to acquire each of the segments to be played back. The source location identifiers identify segments of the main program and/or the one more advertisements to be played back, and the sequence of the playback. Further in some embodiments, the source location identifiers define a storage location and/or network address where the media file of the multimedia content for the segment can be obtained. For example, in some embodiments the source location identifiers are Uniform Resource Identifiers (URI), Uniform Resource Locators (URL), or other such location identifiers and/or combinations of such location identifiers, that can be utilized by the CE device playing back the media stream to access and acquire the multimedia segments. For example, a CE device can use the source location identifiers defined within a playlist file to access a remote source over the Internet or other distributed network to acquire the segments. For simplicity, the following discussion will refer to the source location identifiers as a URI. It is noted, however, that the source location identifiers are not limited to URIs, and instead can be other relevant location identifiers. In some instances, the media stream can include a single playlist file for the stream that continues to be updated by one or more sources of content, while in other implementations a playlist file can be associated with a first main program, while a subsequent main program has a corresponding different playlist file.

Still referring to FIG. 1, in step 114 the media stream is evaluated to identify one or more advertisement content within the media stream. In step 116, the URIs of segments are identified in the playlist file corresponding to the identified advertisement content. Again, advertisement content can comprise one or more segments, multiple advertisement content can be included into a single segment, and multiple advertisement content can span multiple segments.

In step 118, one or more replacement advertisement content are identified and/or selected to replace the identified advertisement content in the media stream. It is noted that in some instances one or more advertisement content may be maintained and not replaced while other advertisement content of the media stream may be replaced. As described above and more fully below, replacement advertisement content can be selected as potentially being more relevant to one or more intended or targeted CE device and/or one or more targeted users at one or more CE devices. In step 120, one or more URIs of segments of the replacement advertisement content are identified. These replacement URIs can be defined for content accessed over the Internet or other network, local content at a CE device, or other such sources.

In step 122, the playlist file for the media stream is modified to replace the URIs of the segments of the advertisement content of the media stream to be replaced with the URIs of segments for the replacement advertisement content. As described above, the process 110 can be utilized with live media streams and as such the modification of the playlist file can, in some embodiments, be performed substantially in real time as the media stream is being received such that minimal delay, if any, is introduced after the playlist file is received in forwarding the modified playlist file to a CE device to be utilized in playing back the main program content, the replacement advertisement content, and any advertisement content maintained in the playlist file. In some implementations the delay introduced as a result of modifying the playlist file is so small that viewers would be unaware of any delays. In some embodiments, the delay resulting from the modification of the playlist file is typically less than 10 seconds, usually less than five seconds, and in some instances less than one second. A live media stream can include substantially any media stream captured of a live event (e.g., football game, basketball game, auto racing and/or other sporting events, the Academy Awards, the Grammy Awards, a music concert and/or other entertainment events, or the like) that is forwarded over the distributed network (e.g., streamed over the Internet) or otherwise distributed over a combination of methods. The modification to playlists can alternatively be applied to prerecorded or non-live content.

In step 124, the modified playlist file is communicated to one or more targeted CE devices. In some embodiments the modified playlist file is streamed in substantially real time over the Internet or other network to a targeted remote CE device configured to receive the playlist file and playback multimedia content as defined in the modified playlist file. Utilizing the modified playlist file the targeted CE device can acquire the segments of the main program segments, which may be a substantially live program, the segments of the replacement advertisement content, and when relevant segments of other advertisement content.

In some embodiments, the process 110 or portions of the process can be performed simultaneously for multiple different CE devices and/or users. Accordingly, substantially any number of modified playlist files can be generated for different targeted users or CE devices. Similarly, the process 110 can continue to be performed as the media stream continues to be received. For example, when the media stream provides live content, the media stream continues to be captured (e.g., a live sporting event) and distributed with updates to the playlist file. As such, the process 110 can continue to evaluate the media stream, identify advertisement content, identify which if any of the advertisement content is to be replaced, identify replacement advertisement content and replace the URLs for the segments of the advertisement content to be replaced in the playlist file or updated playlist file with URLs for the replacement content before the modified updated playlist file is distributed to one or more CE devices.

For example, some CE devices (e.g., IPTVs) can receive streamed content, and in some instances live streamed content. These CE devices are configured to receive the streamed content via the Internet and playback the content, similar to TVs tuning to a broadcast content (e.g., via cable, satellite or the like). Accordingly, some embodiments continue to receive the live content stream and updated playlist file, replace advertisement content with targeted or more relevant advertisements to a user, and forward the modified updated playlist file to one or more relevant CE devices.

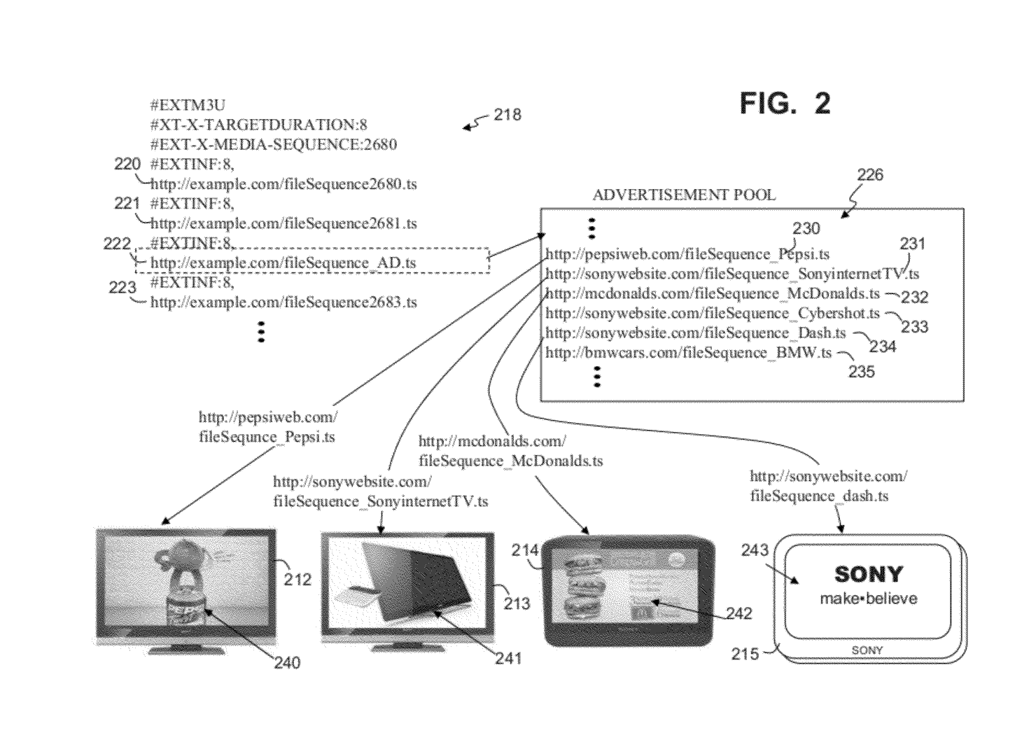

FIG. 2 depicts a simplified block diagram representation of a distribution of modified playlist files to a plurality of CE devices 212-215 such that each of the CE devices is playing back the same main program while playing back at least some different advertisement content. The received playlist file 218 is received that identifies a series of URIs 220-223 corresponding to segments of the main program and/or advertisement content. Upon the detection of an advertisement to be replaced, the corresponding URI for one or more segments corresponding to the advertisement are identified. In the example depicted in FIG. 2 the URI 222, which is highlighted with the dashed box, is identified as corresponding to advertisement content to be replaced with the URI:
http://example.com/fileSequence_AD.ts.

Some embodiments utilize one or more advertisement listings 226, arrays or the like of URIs 230-235 that correspond to a pool or database of potential advertisement contents from which to select appropriate advertisement content to be used as replace advertisement content. The selection of the replacement advertisement can be based on a predefined order (e.g., first-in-first-out, from a top of a list to a bottom, from a sub-list, or the like), based on an evaluation of the potential advertisement content and/or metadata of the potential replacement advertisement content, or other such considerations or combinations of such considerations.

As described above, the replacement advertisement content is typically selected to provide advertisements that are predicted to be more relevant and of interest to a user viewing the media stream. Accordingly, the URI 222 in the playlist file 218 can be replaced with one or more URIs 230-235 from the advertisement listing 226 depending on an intended or targeted user, group of users, CE device, group of CE devices or the like. For example, when modifying the playlist file 218 targeted to be received at a first CE device 212, which can be associated with a targeted first users, it can be determined that there are currently no user preferences known and/or no preferences that are relevant to the potential advertisements in the advertisement pool. Accordingly, the advertisement to be replaced can be replaced with an advertisement that may be more relevant to a current time or a location of the CE device (e.g., an advertisement content advertising a soft drink, such as Pepsi™ can be selected during the summer time). The URI 222 within the playlist file can be replaced with a URI 230 corresponding to a Pepsi advertisement 240, resulting in a modified playlist file. Below is an example portion of a modified playlist file (with the replacement URI 230 shown in italics) that can be distributed to the intended one or more CE devices 212:

#EXTM3U
#XT-X-TARGETDURATION:8
#EXT-X-MEDlA-SEQUENCE:2680
#EXTINF:8,
http://example.com/fileSequence2680.ts
#EXTINF:8,
http://example.com/fileSequence2681.ts
#EXTINF:8,
http://pepsiweb.com/fileSequnce_{—}Pepsi.ts
#EXTINF:8,
http://example.com/fileSequence2683.ts

.
.
.

Similarly, different replacement advertisement content (e.g., advertisement for a Sony Internet Protocol capable TV 241) can be selected for a second user at the second CE device 213 based on the second user's recent Internet searches for electronic TVs. Accordingly, the identified URI 222 in the playlist file can be replaced with the URI 231 (http://sonywebsite.com/fileSequence_SonyinternetTV.ts), resulting in a modified playlist file (with the replacement URI 231 shown in italics):

#EXTM3U
#XT-X-TARGETDURATION:8
#EXT-X-MEDlA-SEQUENCE:2680
#EXTINF:8,
http://example.com/fileSequence2680.ts
#EXTINF:8,
http://example.com/fileSequence2681.ts
#EXTINF:8,
http://sonywebsite.com/fileSequence_{—}SonyinternetTV.ts
#EXTINF:8,
http://example.com/fileSequence2683.ts

.
.
.

Relative to a third user at the third CE device 214 (e.g., a portable wireless CE device), a replacement advertisement content can be identified based on recent or current programs and/or channels watched by a user. For example, a third replacement advertisement 242 for a restaurant with promotions, such as a nearest restaurant, when the user was watching a cooking show or channel (e.g., Food Network™) can be identified, with a corresponding third URI 232. The third URI 232 can replace the initial advertisement URI 222 in the playlist file providing the following modified playlist file (with the replacement URI 232 shown in italics):

#EXTM3U
#XT-X-TARGETDURATION:8
#EXT-X-MEDlA-SEQUENCE:2680
#EXTINF:8,
http://example.com/fileSequence2680.ts
#EXTINF:8,
http://example.com/fileSequence2681.ts
#EXTINF:8,
http://mcdonalds.com/fileSequence_{—}McDonalds.ts
#EXTINF:8,
http://example.com/fileSequence2683.ts

.
.
.

As another example, a fourth client device 215 can receive a modified advertisement based on the content distributor, the type or manufacturer of the CE device or the like. For example, when the CE device 215 is a Sony Dash™ wireless device, and advertisement for Sony™ or a Sony product or service 243 can be selected as the replacement advertisement content with a corresponding URI 234. Accordingly, the playlist file 218 can be modified to replace the advertisement URI 222 with the Sony advertisement replacement URI 234, providing a modified playlist file as follows (with the replacement URI 234 shown in italics):

#EXTM3U
#XT-X-TARGETDURATION:8
#EXT-X-MEDlA-SEQUENCE:2680
#EXTINF:8,
http://example.com/fileSequence2680.ts
#EXTINF:8,
http://example.com/fileSequence2681.ts
#EXTINF:8,
http://sonywebsite.com/fileSequence_{—}Dash.ts
#EXTINF:8,
http://example.com/fileSequence2683.ts

.
.
.

A CE device upon receiving the modified playlist file utilizes the URIs to acquire the relevant media file for the corresponding segment. The CE device typically is unaware that one or more URIs have been replaced and thus the advertisement content that is played back is replaced. Instead, the CE device merely accesses the appropriate source or storage specified by the URI to acquire the relevant media file to be played back in accordance with the playlist file.

When a received media stream includes advertisement content and one or more of those advertisements content may be replaces, some embodiments evaluate the media stream, evaluate and/or playback the advertisement content, evaluate metadata of the media stream, evaluate the playlist file and URIs, and other such content and/or information in identifying the advertisement content. Once identified an evaluation is performed to determine whether an advertisement content is to be replaced. For example, in identifying advertisement content some embodiments evaluate the media stream performing blank frame detection. Often between programming segments, a series of blank or “black” video frames are included that can be a transition between content (e.g., between a main program content and an advertisement content, or between a first advertisement content and a second advertisement content). Additionally, in some instances the series of blank frames my simultaneously be accompanied by a decrease in the audio signal occurring before and after each individual advertisement content. The evaluation of the media stream can use the series of blank frames and/or decrease in audio signal to identify transitions between content. Some embodiments additionally or alternatively employ scene change detection that can be used to detect relatively large changes in video data.

Other evaluations of the media stream can be performed in detecting a logo overlay that was added to the video content, for example by a content produce and/or distributor. Main programming content may include the logo while advertising content typically does not include the logo. Accordingly, some embodiments search for the lack of an overlay or logo. Some implementations employ more sophisticated approaches, such as utilizing acoustic and visual repetition mechanisms to identify advertisement content.

A combination of one or more of the above techniques or other known techniques can be utilized in some embodiments to detect a change in content and/or detect advertisement content. In some instances, a combination of the above is used together where a sequence of non-blank frames are grouped together, and each group is rated based on a combination of factors. For example, the presence of an unchanging logo within a group increases the likelihood that the group is part of the main program, a lot of scene change between blank frames with missing logo increases the likelihood that a group could be part of an advertisement content, durations of the groups, and other factors can be considered. The above techniques can be used with live content, including live streaming content distributed from a content source to a distribution service that identifies the advertisement content and that replaces at least some of the advertisement content. Typically, the media stream and/or playlist file does not include predefined slots into which advertisement content is to be inserted. In some instances, however, the media stream may include identifiers that identify the advertisement content, such as identifiers added in metadata by a content supplier or source.

The selection of advertisement content within the media stream that is to be replaced can be based on one or more factors. Again, not all the advertisement content is necessarily replaced. In some embodiments, the advertisement content is evaluated, an advertisement identifier may be determined and used in determining whether it should be replaced, the advertisement content, the playlist file or other data with the media stream may be evaluated to determine whether the advertisement content is to be replaced, an identification of a source of the media stream and/or the advertisement content can be determined, a URI or portion of a URI, an evaluation of the advertisement content itself, a duration of the advertisement content, flags or other notifications identifying advertisement content and/or advertisement URIs that can potentially be replaced, an identification of a product or service being advertised can be determined, and other such information can be used in determining whether advertisement content is to be replaced. For example, in some instances predefined advertisement content is replaced, such as based on a location within the playlist file and/or media stream, based on playback timing of the media stream, based on a position within a series of advertisement content (e.g., a third advertisement content of a series of four advertisement content is to be replaced), and/or other such determinations. It is noted that in some instances an advertisement content that has been identified as being replaceable may not be replaced, for example, when the advertisement content is relevant to a user, when a limit of replacements has been met, a duration is inconsistent with potential replacement advertisement, or other such factors or combinations of such factors.

Similarly, the selection of which replacement advertisement content is to be incorporated into the playlist file can be based on one or more factors and/or parameters. Often, information about a user and/or a CE device is used to select content. For example, a user profile and/or database can be maintained for one or more users and the relevance parameters and/or information maintained in the profile and/or associated with a user or CE device can be used to select replacement advertisement content. A user may specifically identify types of advertisement content the user is interested in viewing. A user's prior actions can additionally or alternatively be considered. In some instances, relevancy of advertisement content may be determined based on a user's or the CE device's geographic location (e.g., a global positioning location within the world, a country, a zip code, or other such location information), previous content viewed by a user and/or on a CE device, recent search requests, recent purchases made by a user, or other such parameters or combinations of such parameters. Other relevance parameters or factors may also be considered such as contractual obligations between the distributor and one or more other entities (e.g., the content source, a manufacturer trying to advertise, and the like), regulations, laws, playback duration, position within playback, time of day, time of year, location, and other such relevant parameters and/or factors. The potential replacement advertisement content can further include metadata, and/or tables, databases and/or the like can be generated that allow the modified playlist file distributor to identify replacement advertisement content. The selection of replacement advertisement content further depends on a duration of the advertisement content. Accordingly, the duration of the advertisement content is determined and replacement advertisement content is selected to fit within the duration and/or be modified to fit within the duration.

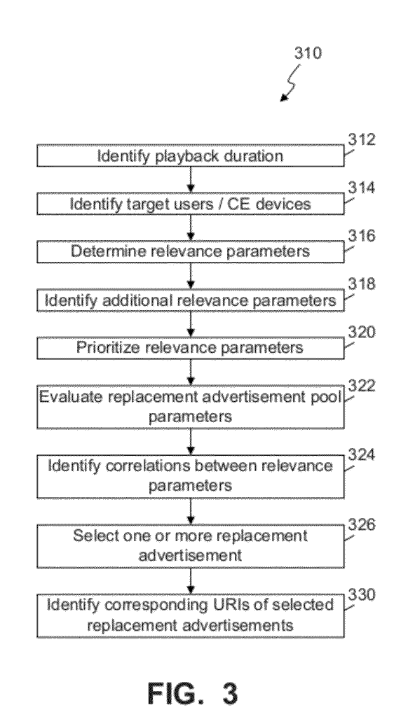

FIG. 3 depicts a simplified flow diagram of a process 310 of selecting replacement content according to some embodiments. In step 312, a playback duration is identified corresponding to the one or more segments to be replaced and into which one or more segments of advertisement content are to be placed. In step 314, one or more target users or CE devices are identified. In step 316, information corresponding to the targeted one or more users and/or CE devices is identified and evaluated to determine relevant parameters. The information can be a table or listing of relevance parameters, a user profile, location information, regulations, limits and/or other such information. Again, a user profile or other database can be maintained relevant to a user or group of users and relevance parameters can be extracted from the profile, database or the like. The profile or database can include substantially any relevant parameter that may be utilized in selecting advertisement content. Further, the profile and/or database is typically continuously updated so that the selection of replacement advertisement content is current and relevant. Relevance parameters that can be considered include, but are not limited to, location information, current time, content viewing history, shopping history, purchase history, recent searching history, identified interests, user preferences, specified interests, currently logged-in user's profile (e.g., different users of a household may view a TV at different times), other users' actions, and the like.

In step 318, additional relevance parameters may be considered that can have an effect on the selection of replacement advertisement content. Examples of some additional parameters include, but are not limited to, current time of day, time of year, approaching holidays, upcoming and/or current events (e.g., the Super Bowl, the Academy Awards, the Olympics, movie releases, etc.), etc. Other parameters may further include restrictions, such as parental set restrictions, regulations, laws, time of day, type of main program into which the replacement advertisement content is to be incorporated (e.g., children's programming versus mature audience programming), and other such restrictions. Similarly, there can be addition factors such as contractual parameters, limits set by the content provider and other such factors.

In step 320, the relevance parameters are prioritized and/or a prioritization of relevance parameters is identified. This prioritization may be predefined, may be modified over time, and in some instances, may be user dependent. For example, the prioritizing may change as a user's actions or habits, based on a user's increased interest in certain types or genres of content, changes in interest in CE devices and/or products, changes in the time of year or a location, and the like. Additionally, in some implementations, prioritization can be weighted or actions given greater importance to more recent events or user activities (e.g., recent search queries, recent videos viewed, recent music or songs played, etc.). Other parameters can also be taken into consideration in prioritizing, such as parameters identified in a currently logged-in user's profile (e.g., child, parent, teen, etc., parental limits, and other such parameters).

In step 322, information of the replacement advertisement pool and/or corresponding tables or databases are parsed and evaluated based on the duration of the segments to be replaced, duration of potential replacement advertisements, the prioritization, parameters and other relevant factors. The information relevant to the potential replacement advertisement content can include substantially any relevant information, including information such as, but not limited to, the above described relevance parameters, playback duration, subject of the advertisement content, the advertiser, source of the advertisement content, and other relevant information.

In step 324, correlations between durations, the relevance parameters and the information and/or parameters of the advertisement pool are identified for one or more of the replacement advertisement content. In step 326, one or more replacement advertisement content are selected based on the correlations. In some instances the correlation is in part dependent on the priority of correlated parameters, and/or a prioritization of replacement advertisement content based on the differences in correlation with the relevance parameters. In step 330, corresponding URIs are identified for the selected one or more replacement advertisements. The URIs can then be inserted into the modified playlist file, such as in step 122.

The user profile and/or other relevance parameters can be collected and/or obtained by the service or source that distributes the modified playlist files, by a third party service or a combination thereof. In some embodiments, users register as users and/or register CE devices with the service that distributes the modified playlist files. This registration can include providing parameter information, preferences, settings and the like. Similarly, the registration can include collecting information about desired content, such as a viewing list of content. Additionally, the CE device may in some instances communicate parameter information to the distribution service that can be used in selecting replacement advertisement content (e.g., search histories and/or purchases conducted through the CE device or a device in communication with the CE device, recently viewed content, recently recorded content, games recently played, user settings, etc.). Similarly, in some instances, the CE device accesses the distribution service that distributes the modified playlist files to take advantage of other features, acquire other content, and the like. For example, the CE device may access third party services through the distribution service. As a specific example, the distribution service may be a service provided by a CE device manufacturer and/or services associated with a CE device manufacture (e.g., BRAVIA Internet Video Link (BIVL) content service) or other similar services, which may also provide access to other services over the network such as, but not limited to, shopping, gaming, third party video source and the like (e.g., Sony Pictures Entertainment™, Sony BMG Music™, Sony PlaySation® Network, Netflix Service™, Amazon Video on Demand™, YouTube™, Yahoo!™, and other third party services). Typically, however, the CE devices and users are unaware of the modifications to the playlist and/or the distribution services and how the modified playlist is generated or modified, and instead merely receive the modified playlist and plays back the relevant content according to the received playlist without knowledge of the modifications. The modifications to the playlists are determined by the distribution service.

In some embodiments, the distribution service that distributes the modified playlist files can communicate with one or more other services to obtain additional or alternative parameters. These other services can be content sources, social network services, shopping services and/or other services. Similarly, the distribution service can communicate with content source providers, content distributers, advertisers and the like to obtain limits, restrictions, parameters, preferences, and other relevant information that can be used in indentifying advertisement content within a media stream and/or selecting replacement advertisement content. For example, the distribution service that distributes the modified playlist files can communicate with advertisers to receive advertisement content and/or parameters to consider in identifying users for which advertisement content would be relevant. These communications can occur over time to provide updated parameters, updated advertisement content and the like. Similarly, information about other individuals and their preferences, history and the like, can be obtained and utilized in determining relevance of advertisement content, such as other individuals associated with a user through a social networking service. Still further, a user can provide feedback about content and/or advertisement content that can be used in the selection of subsequent replacement advertisement.

Upon receiving the modified playlist file the CE device can used the modified playlist file to acquire the segments of the main program, the segments of the replacement advertisement, and when relevant the segments of advertisements content that were maintained and not replaced. The URIs defined in the modified playlist file allow the CE device to access and acquire the segments to be played back sequentially as defined by the modified playback device. The URIs can direct the CE device to substantially any source accessible by the CE device, including but not limited to, the service distributing the modified playlist file, local on the CE device, a content source (e.g., a TV broadcast source), an advertiser service, or other relevant sources. In many instances, the segments of content are obtained from over the Internet using the URIs to access a remote source.

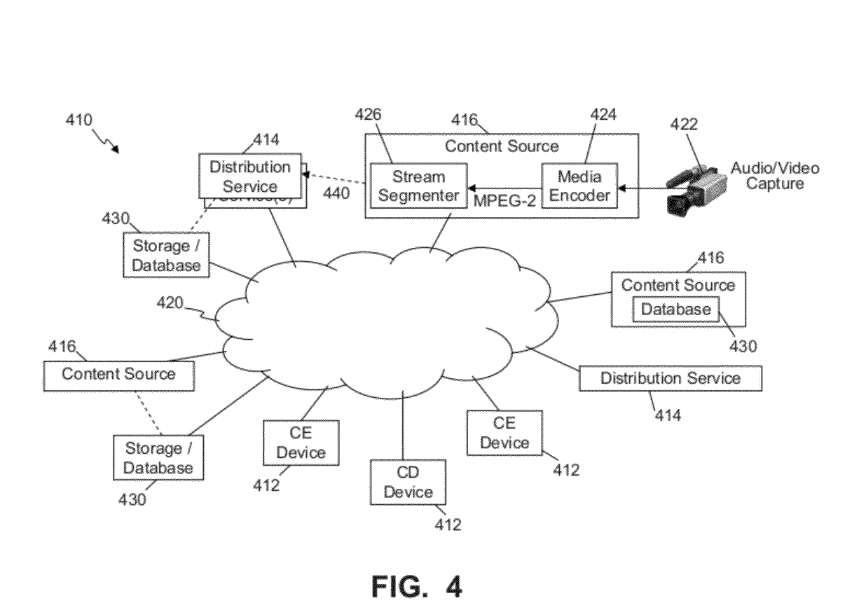

FIG. 4 depicts a simplified block diagram of a system 410 configured to provide the distribution of modified playlist files to be used at CE devices 412 in acquiring and playing back multimedia content according to some embodiments. The system includes one or more CE devices 412, one or more distribution services or servers 414, one or more content sources 416, and a distributed network 420 providing communication channels or links between the devices of the system 410. The distribution service 414 is remote from the CE devices 412, and the CE devices 412 can communicate over the distributed network 420 with the distribution service 414 to receive the modified playlist files, and in some instances some or all of the main program segments and/or some or all of the advertisement or replacement advertisement segments. Additionally, the CE devices 412 may further be in communication over the network 420 with one or more of the remote content sources 416 to acquire segments of the main program, advertisement segments and/or replacement advertisement segments.

In some embodiments, the content source 416 is an originating source of content that captures the audio/video content, such as through a video camera and/or other such equipment 422. For example, when the media content is a live media stream, the content source can receive the media content from a video camera 422 and process the live media content in real time. In other instances the source may be previously recorded content and/or a combination of previously recorded and live content, with the previously recorded content being accessed by the content source 416 and/or stored at the content source. The content source 416 can encode the content, such as through one or more relevant encoders 424 performing desired encoding depending on intended receiving CE devices, and in some instances the content source encapsulates the content into a format suitable for delivery and/or distribution. The encoding can be parallel encoding according to a single encoding scheme, parallel encoding according to multiple different encoding schemes or other relevant encoding. For example, the content can be encoded and encapsulated according to MPEG-2 with the MPEG-2 transport stream that is forwarded to a segmenting device or segmenter 426. In some instances the encoder 424 further incorporates advertisement content within the captured content. Metadata may also be incorporated, such as advertisement identifiers, source identifiers, product identifiers, parameters that can be used in determining relevance to users, main program title, other main program information and other relevant metadata. Further, the content source 416 generates a playlist file that includes the URIs for the main program segments as well as the advertisement segments. Again, the encoding, encapsulation and generation of the playlist file can occur in real time, such as with multimedia content of a live event.

The segmenting device 426 segments the encoded content into segments. In some instances some or all of the segments of the content can be segmented to have substantially equal playback durations. Again, the segmenting device 426 can perform segmenting in real time, such as when the content is live content. Further, the segmenting device 426, and/or the content source 416, generates the playlist file defining the sequence of the segments and including the URIs. In some instances, the playlist file and/or the media stream can be further configured with additional metadata as described above and below.

A media stream available from the content source 416 can be received at the distribution service 414. In some instances, a direct link 440 between the content source 416 and the distribution service 414 may be established, while in other instances the media stream may be obtained via the distributed network 420. The media stream received at the distribution service 414 typically includes the playlist file and the multimedia content, where the multimedia content may in some instances be received separate from the playlist file and/or acquired utilizing the URIs defined within the playlist file. As such, the actual segments of multimedia content of the media stream may be obtained from a different content source 416 or a storage or database 430 that may be part of or separate from the content source. In some embodiments, the distribution service 414 does not retain, store or buffer the main program segments and/or the advertisement content segments when received and evaluated.

The distribution service 414 evaluates the media stream to identify one or more advertisement content that may be replaced with one or more replacement advertisement content. The identification and selection of advertisement content to be replaced can include receiving a notification (e.g., from the content source 416) of advertisement content that is available to be replaced; receiving notification of advertisement content that should not be replaced; detecting identifiers within metadata, the playlist file and/or the segments; evaluations of the segments and/or the contents of the segments and the like.

The selection of replacement advertisement content can similarly include an evaluation of metadata of the media stream, identifiers and the like. Further, the distribution service 414 typically maintains one or more pools or listings of replacement advertisement content, and one or more databases, listings or tables that identify relevance parameters. In some embodiments, the relevance parameters for advertisement content already within the media stream are considered by the distribution service 414 in relation to relevance parameters of one or more targeted users or CE devices. Based on the relationship between advertisement relevance parameters and user or CE device relevance parameters the distribution service 414 can prioritize and/or select replacement advertisement content. Again, in some instances one or more of the advertisement content in the media stream may be maintained in the media stream and not replaced. For example, the media stream may define an advertisement content as non-replaceable; the relevance parameters of an advertisement content in the media stream may correspond to a user's relevance parameters; the metadata may identify the product or company associated with the product or service being advertised and the distribution service 414 may identify that advertisements for such a company should be maintained; or other relevant factors.

When a replacement advertisement is identified the URIs for the segment or segments of the advertisement content are identified. The segments of replacement advertisement content may be stored at the distribution service 414, at one or more content sources 416, on one or more separate storage or databases 430 or a combination thereof. The playlist file is modified by the distribution service 414 based on the identified replacement advertisements with the URIs for the segments of the replacement advertisement content. As described above, in some instances the distribution service may receive updated playlist files, such as when the media stream is a live event. Accordingly, the distribution service 414 can continue to receive the updated playlist file, and can continue to modify and distribute the updated playlist file. Again, the one or more distribution service 414 and/or content sources 416 may provide live content (such as the output of a video) or pre-recorded content, such as a media file or disc that is formatted into segments for distribution over the distributed network 420 (e.g., streamed over the distributed network). In some instances with live content, live playlist files can be created in real time and modified in real time, and the playlist file may include information about the content and/or segments that have not yet been written. Additionally, in some embodiments, a single playlist file is modified to replace with URIs for segments of advertisement content. Again, the single playlist file may be updated, but playback in accordance with these embodiments is based on the single playlist file until a different content stream is selected, where the CE device acquires segments as defined by the single playlist file.

The CE devices 412 receive the playlist file and use the URIs to access and acquire the segments of content from the distribution service 414 and/or one or more content sources 416. Once obtained the segments of multimedia content are played back in accordance with the playlist file. The CE devices 412 can be substantially any relevant CE device configured to receive the playlist file and multimedia content segments. For example, the CE devices 412 can be televisions (e.g., IPTVs), an IP enabled disc or other portable medium player (e.g., Blu-ray player), a Dash® device, tablet device, an electronic gaming device, computer, laptop and/or other such CE devices.

The one or more distribution services 414 can be substantially any server, device or collection of devices configured to modify the playlist files and distribute the modified playlist files and/or modified updated playlist files. For example, one or more of the distribution services 414 can be servers operating under the BRAVIA Internet Video Link (BIVL) service provided by Sony Corporation. Again, the playlist files forwarded by the distribution service 414 can direct the CE device to other sources (e.g., other servers or storage associated with the distribution service 414, content sources 416 or the like) for the program and advertisement segments. Further, one or more of the content sources 416 may be distributed over the network 420 and/or cooperated with other servers. The network 420 can be the Internet, a WAN, a LAN or other such networks or combinations of such networks that are configured to allow the distribution of media streams and media files.

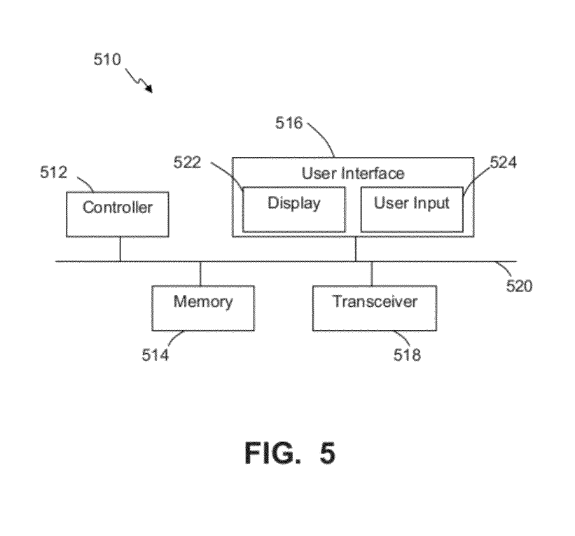

The methods, techniques, devices, servers, services, sources, systems and the like described herein may be utilized, implemented and/or run on many different types of systems. Referring to FIG. 5, there is illustrated a system 510 that may be used for any such implementations, in accordance with some embodiments. One or more components of the system 510 may be used for implementing any system, apparatus or device mentioned above or below, such as for example any of the above or below mentioned CE devices 412, distribution service 414, content sources 416, etc. However, the use of the system 510 or any portion thereof is certainly not required.

By way of example, the system 510 may comprise a controller or processor module 512, memory 514, a user interface 516, and one or more communication links, paths, buses or the like 520. A power source or supply (not shown) is included or coupled with the system. The controller 512 can be implemented through one or more processors, microprocessors, central processing unit, logic, local digital storage, firmware and/or other control hardware and/or software, and may be used to execute or assist in executing the steps of the methods and techniques described herein, and control various communications, programs, content, listings, services, interfaces, etc. The user interface 516 can allow a user to interact with the system 510 and receive information through the system. In some instances, the user interface 516 includes a display 522 and/or one or more user inputs 524, such as a remote control, keyboard, mouse, game controller, buttons, touch screen, etc., which can be part of or wired or wirelessly coupled with the system 510.

Typically, the system 510 further includes one or more communication interfaces, ports, transceivers 518 and the like allowing the system 510 to communication over the distributed network 420, other networks, buses or communication channels with other devices and/or other such communications. Further the transceiver 518 can be configured for wired, wireless, optical, fiber optical cable or other such communication configurations or combinations of such communications. The system 510 comprises an example of a control and/or processor-based system.

The memory 514, which can be access by the controller 512, typically includes one or more processor readable and/or computer readable media accessed by at least the controller 512, and can include volatile and/or nonvolatile media, such as RAM, ROM, EEPROM, flash memory and/or other memory technology. Further, the memory 514 is shown as internal to the system 510; however, the memory 514 can be internal, external or a combination of internal and external memory. The external memory can be substantially any relevant memory such as, but not limited to, one or more of flash memory secure digital (SD) card, universal serial bus (USB) stick or drive, other memory cards, hard drive and other such memory or combinations of such memory. The memory 514 can store code, software, executables, scripts, data, content, multimedia content and/or segments, playlist file(s), programming, programs, media stream, media files, textual content, log or history data, user information and the like. In some embodiments, the memory 514 stores software that implements the user interfaces and allows the user to interact with the system 510.

The system 510, in some embodiments, may optionally include one or more media encoders 424 and/or one or more segmenting devices 426. For example, the system 510 in implementing a content source 416 may include an encoder 424 and/or segmenting device 426. The encoder 424 and/or segmenting device 426 can be implemented through hardware, software or combination of hardware and software.

In some embodiments, one or more of the embodiments, methods, processes, approaches, and/or techniques described above or below may be implemented in a computer program executable by a processor-based system. By way of example, such a processor based system may comprise the processor based system 510, or a computer, IP enabled television, IP enabled Blu-ray player, entertainment system, game console, graphics workstation, cellular phone, smart phone, tablet, etc. Such computer programs may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques for allowing the generation of a media stream, the modifying of the playlist, the distribution of the modified playlist, a CE device 412 to access a distribution service 414, content source 416, storage or database 430 and/or other services or sources over the distributed network 420. As another example, such computer programs may be used for implementing any type of tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium for embodying a computer program for input to a processor or computer and a computer program embodied in the medium for causing the processor or computer to perform or execute steps comprising any one or more of the steps involved in any one or more of the embodiments, methods, processes, approaches, and/or techniques described herein. For example, some embodiments provide a computer-readable storage medium storing a computer program for use with a computer simulation, the computer program adapted to cause a computer and/or processor based system to execute steps comprising: receiving, at a distribution service accessible by CE devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back; identifying, within the media stream, a first advertisement content; identifying, within the playlist file, one or more source location identifiers corresponding to one or more segments of the first advertisement content; identifying a first replacement advertisement content to replace the first advertisement content; identifying one or more source location identifiers corresponding to one or more segments of the first replacement advertisement content; modifying in substantially real time the playlist file, the modifying comprising replacing each of the one or more source location identifiers corresponding to the segments of the first advertisement content defined within the media stream with the one or more source location identifiers corresponding to the one or more segments of the first replacement advertisement content producing a modified playlist file; and communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

Other embodiments provide one or more computer-readable storage mediums storing one or more computer programs for use with a computer simulation, the one or more computer programs adapted to cause a computer and/or processor based system to execute steps comprising: receiving, at a distribution server accessible by consumer electronic (CE) devices via the Internet, a substantially live media stream, the media stream comprising visual multimedia content and a playlist file defining the playback of the visual multimedia content, where the visual multimedia content comprises main program content segments and advertisement segments, and the playlist file comprises source location identifiers that are configured to be used by a CE device to acquire the plurality segments to be played back; identifying, within the media stream, a first advertisement content; identifying, within the playlist file, source location identifiers of one or more segments of the first advertisement content; identifying a first replacement advertisement content to replace the first advertisement content; identifying one or more source location identifiers of one or more segments of the first replacement advertisement content; modifying in substantially real time the playlist file comprising replacing each of the one or more source location identifiers of the one or more segments of the identified first advertisement content defined within the media stream with the one or more of the source location identifiers of the one or more segments of the first replacement advertisement content; and streaming in substantially real time, from the distribution server, the modified playlist file over the Internet to a targeted remote CE device, where the modified playlist file is configured to be utilized by the targeted CE device in acquiring the segments of the substantially live main program and the one or more segments of the first replacement advertisement content.

Some embodiments provide for the modification of a playlist file of a media stream to replace advertisement content with different and usually more relevant advertisement content. This modification of the playlist can be implemented with live or prerecorded media streams. The modified playlist file for the media stream is distributed to one or more CE devices 412, such as to one or more IPTVs. The distribution of the playlist is over the distributed network 420, and in some instances is distributed via live streaming using Hypertext Transfer Protocol (HTTP). The modified playlist received by the one or more CE devices provides the CE devices with the ability to play live video content via Internet, which in at least some instances would be similar to the tuning in by CE devices to broadcast content (e.g., a TV tuning to a channel to receive content delivered via cable). With live content, the main program segments, replacement advertisement segments, and advertisement segments that are not replaced, can be acquired by the CE device 412 over the distributed network 420 soon after it is created allowing it to be viewed in near real time. Typically, the live media stream is divided into multiple segments. In some instances some segments, if not all segments, have the same duration. The segments can be sent over the Internet according HTTP and based on the URIs for each corresponding segment identified in the modified playlist file. The CE device 412 can access the segments by parsing the modified playlist file, using the URIs to access the relevant source, receive the segments over the Internet, and play back the segments, which in some instances can include playing back the segments as a contiguous stream. The modified playlist file allows targeted or relevant advertisements to be directed a targeted user or CE device based on one or more CE device characteristics (e.g., location, capabilities, access level, etc.), user preferences, current context, recent user searches, recent user purchases, other users' preferences, searches or purchases, or other such factors.

Again, some embodiments use HTTP protocol for delivering live streaming content. For example, in some instances the content is streamed in compliance with an HTTP Live Streaming standard defined by Internet Engineering Task Force (IETF). Other methods, standards, protocols or the like can additionally or alternatively be utilized in distributing the playlist files, the modified playlist files and/or the segments of the main program contents, advertisement content, replacement advertisement content or other relevant content. For example, some embodiments may employ Real-time Transport Protocol (RTP), Real Time Streaming Protocol (RTSP) or other such protocols in distributing the playlist file, modified playlist file or content segments. The use of HTTP, however, may simplify the implementation is some instances, taking advantage of the wide spread use of HTTP on the Internet. Further, HTTP is a relatively simple protocol, well implemented and supported by several web servers. Many of these web servers are available as open source, already mature and widely deployed (e.g., Apache Web Server). Another advantage of using HTTP is that it typically does not need additional changes on Network Address Translation (NAT) or firewall settings and generally no additional ports need to be opened. Additional, some implementations using HTTP can take advantage of web server caches on edge network distribution systems.

In providing the media stream (e.g., IPTV live streaming) in accordance with some embodiments, a content source 416 can encode the input multimedia content of the media stream, such as encoding digitally, and encapsulate the content in a format suitable for delivery over the distributed network 420 (e.g., MPEG-2 TS). The multimedia content can include advertisement content and/or advertisement content can be incorporated prior to or during encoding. The resulting encoded multimedia content of the stream can then be divided into segments, and URIs or other relevant source location identifiers designated in a generated playlist file, which contains URIs for each media segment.

The playlist file is received at a distribution service or server 414 that identifies advertisements and modifies the playlist file to replace one or more URIs corresponding to segments of advertisement content with replacement URIs corresponding to segments of replacement advertisement content. In some instances the playlist file, segments of the multimedia content and/or the media stream may be received over the distributed network 420, received via a portable computer readable medium, or the like. The distribution service 414 in identifying the segments of advertisement content to replace can evaluate the segments of the media stream, evaluate URIs of the playlist file, evaluate metadata of the playlist file and/or media stream, receive a listing of advertisement content and/or identifiers of advertisement URIs, and/or consider other relevant information. The distribution service 414, in some embodiments, can be implemented through one or more servers that act independently or cooperatively. In some implementations, standard servers can be employed that are configured to identify the advertisement content and modify the playlist file, such as standard HTTP web servers.

Some embodiments can additionally or alternatively insert additional content, such as insert advertisement content into a media stream without replacing advertisement segments already defined within the playlist file. For example, the distribution service 414 may insert advertisement content when the multimedia content does not have advertisement content or when additional advertisement content is desired. In some instances, the distribution service 414 can modify the playlist file to insert one or more additional or new URIs. Further, in some instances, additional or now URIs may be inserted at regular intervals through the media stream. In many instances, however, the insertion of additional URIs corresponding to additional advertisement content or other content may be limited to prerecorded content and/or content for which the playback duration of the content is known (e.g., prerecorded movies or other such content, such as from Netflix, YouTube, movie or television studio, or other such source). For example, one or more new tags (e.g., EXT-X-INSERTEDAD) could be added into the playlist file to identify the new inserted one or more segments to be played back. Below is an example of a portion of a modified playlist file with the added tag EXT-X-INSERTEDAD:

#EXTM3U
#XT-X-TARGETDURATION:8
#EXT-X-MEDlA-SEQUENCE:2680
#EXTINF:8,
http://example.com/fileSequence2680.ts
#EXTINF:8,
http://example.com/fileSequence2681.ts
#EXTINF:8,
#EXT-X-INSERTEDAD
http://sonywebsite.com/fileSequence_Dash.ts
#EXTINF:8,
http://example.com/fileSequence2683.ts
#EXTINF:8,
http://example.com/fileSequence2684.ts
#EXTINF:8,
#EXT-X-INSERTEDAD
http://sonywebsite.com/fileSequence_SonyInternetTV.ts

.
.
.

In some implementations, additional or new advertisements are often not incorporated for live content as this may interfere or hamper the watching experience. Further, in some instances the duration of additional advertisement content may not be added in the total duration of the content. The duration of the content can remain fixed, while a total duration of the actual playback continues for longer than the specified duration of the content due to the inserted advertisement content. In some embodiments, the CE device when parsing the new tag or tags does not include the added URI in performing duration calculations and/or estimations.

One or more techniques or mechanism can be utilized in identifying the advertisement content to be replaced. Some embodiments utilize a blank frame detection that detects a series of “black” or blank video frames between main program segments. In some instances the blank frames may be simultaneously accompanied by a decrease in the audio signal and/or volume occurring before and/or after each individual advertisement that may be detected. Other methods detect scene changes within the media stream, which in some instances is based on relatively significant or large changes in video data. Further methods detect the change or lack of a mark, overlay, logo, displayed identifier or the like. In some instances, a content source may incorporate an overlaid logo or identifier onto one or more frames of the main program content, while the logo is typically not included on advertisement content. Accordingly, some embodiments use the detection that a logo is no longer present as a trigger for the detection of advertisement content. Other methods may be used such as visual and/or acoustic repetition mechanisms. Further, multiple methods can be used in cooperation to identify advertisement. For example, sequences of non-blank frames can be grouped together and these groups can be rate based on a combination of factors.

The distribution service 414 distributes the modified playlists to CE devices 412. Some embodiments modify the playlist file based on one or more targeted users and/or CE devices. The replacement advertisement can be selected based on parameters relevant to one or more users and/or the CE devices. Accordingly, the selected replacement advertisement content are identified and predicted to be more relevant to the user based on factors or parameters such as, but not limited to, user or CE device location (e.g., country, state, zip code, etc.), recent user activity (e.g., recent search queries, recently watched programs, recent purchases), user's preferences and/or profile, based on business contracts (e.g., advertisement content for CE devices from a certain manufacturer), and other such factors. Furthermore, acoustic and visual repetition mechanisms, and/or other detection methods can be used to identify one or more segments as advertisement content, and can enable the distribution service 414 to determine which advertisement content to maintain in the media stream and which to replace. In many instances, the final decision to maintain or replace advertisement content is controlled by the distribution service 414.

The CE device 412 can download the modified playlist file and then use the URIs specified in the modified playlist file to obtain each media file for segments of multimedia content corresponding to the URIs specified in the playlist file. The received media files can then be decoded and played back. Further, in some embodiments, the modified playlist file can continue to be updated with additional URIs for main program segments, advertisement segments and/or modified advertisement segments as time goes on, such as with live content. Additionally, the received media segments can be presented, in some instances, as a contiguous stream on the CE device 412.

The ability to replace advertisement content based on one or more targeted users and/or CE devices can provide enhanced user experience as well as enhanced marketing. The incorporation of more relevant advertisement content increases the likelihood a user actually watches the advertisement content, interacts with the advertisement content and/or makes a purchase decision based on the advertisement content. Further, some embodiments incorporate metadata associated with the targeted advertisement content that could be used for further interactivity, such as links to social network services (e.g., Facebook™, Twitter™, etc.), the user interacting with a browser to make a purchase, and the like. In some instances, revenue may be obtained through the targeted advertisement insertion, such as a distribution service 414 receiving revenue to incorporate certain advertisement content when relevant, establishing revenue sharing agreements (e.g., revenue for each use of an advertisement, revenue for each user that watches an advertisement, revenue when a user interacts with advertisement content and/or makes a purchase based on the replacement advertisement, and the like), or other such revenue schemes.

Accordingly, targeted advertisement can be directed to CE devices, which provides for dynamic switching of advertisement content and can increase the relevance of the advertisement to a targeted user and/or CE device. In many embodiments, the replacement of URIs within the modified playlist file allows targeted advertisement to be directed to a CE device while the CE device is unaware of the modifications, and does not need additional changes at the CE device or in software implemented at the CE device. Further, the distribution of multimedia content over the distributed network 420, such as through HTTP live streaming, allows CE devices, including CE devices that do not have broadcast turners or other relevant turner functionality (e.g., some Blu-ray player, some tablet devices, some laptops, some gaming devices, gaming devices, wireless Internet devices, Dash™ devices, and other relevant devices), the ability to playback content (including content that is typically received via radio frequency (RF) communication, cable, satellite or the like) without the extra tuner hardware. The distribution of more relevant advertisement content to CE devices increases the likelihood that users may watch the advertisement content enhancing the overall experience. In addition, revenue streams can be established through the targeted insertion of advertisement, and accordingly streaming of content, including live streaming, with targeted advertisement content is beneficial with CE devices, including tuner-less CE devices, to receive live broadcasts and other content, as well as potentially providing revenue.

Some embodiments provide techniques that are performed at a distribution service 414 and/or content source 416 that provide for the replacement and insertion of targeted advertisements intended to be distributed to one or more targeted users and/or CE devices. Typically, the CE devices do not have to have special functionality, software or the like to take advantage of and playback the targeted advertisement. Instead, the CE devices continue to access and utilize the modified playlist file as sent by the distribution service. In some embodiments, the CE device may communicate with the distribution service or a third party service in providing profile information, preferences, habits, recent actions and the like. Similarly, the distribution service may cooperate with one or more third party services in acquiring some parameter information that can be used in selecting replacement advertisement content. These third parties can be substantially any relevant third party that can provide information that may be used in selecting replacement advertisement content.

Some embodiments in identifying one or more advertisement content to be replaced receive a notification from a remote source (e.g., a content source 416) identifying the one or more advertisement content as advertisement content to replace. Similarly, some advertisement content of the media stream may be identified by a remote source as advertisement content that is not to be replaced. Further, some embodiments in identifying one or more advertisement content to be replaced can evaluate the media stream, identify a subject of advertisement content, and determine or select one or more advertisement content to be replaced at least based in part on the subject of the advertisement content. The subject can be determined from metadata, identification within the visual or audio content, from the URI or other such information. Accordingly, the evaluation of the media stream can comprise evaluating metadata defined within the media stream, evaluating source location identifiers, identifying sources of each of the first plurality of advertisement content, and/or other such information in determining which advertisement content of the media stream is to be replaced.

In some embodiments, methods of distributing visual multimedia content are provided. Some of these methods comprises: receiving, at a distribution service or server accessible by CE devices via the Internet, a substantially live media stream, the media stream comprising visual multimedia content and a playlist file defining the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the segments to be played back; identifying, within the media stream and relative to a targeted CE device, a first plurality of advertisement content; identifying, within the playlist file, source location identifiers of segments of each of the first plurality of advertising content; identifying a first plurality of replacement advertising content to replace the first plurality of advertisement content; identifying source location identifiers of segments of each of the first plurality of replacement advertising content; modifying in substantially real time the playlist file comprising replacing each of the source location identifiers of the segments of the identified first plurality of advertisement content defined within the media stream with one or more of the source location identifiers of the first plurality of replacement advertising content; and streaming in substantially real time, from the distribution server, the modified playlist file over the Internet to the remote, targeted CE device configured to be utilized by the targeted CE device in acquiring the segments of the main program content segments and the segments of the first plurality of replacement advertising content.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of distributing visual multimedia content, the method comprising:
receiving, at a distribution service accessible by consumer electronic (CE) devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back;
identifying, within the media stream, a first advertisement content;
identifying, within the playlist file, one or more source location identifiers corresponding to one or more segments of the first advertisement content;
identifying a first replacement advertisement content to replace the first advertisement content;
identifying one or more source location identifiers corresponding to one or more segments of the first replacement advertisement content;
modifying in substantially real time the playlist file, the modifying comprising replacing each of the one or more source location identifiers corresponding to the segments of the first advertisement content defined within the media stream with the one or more source location identifiers corresponding to the one or more segments of the first replacement advertisement content producing a modified playlist file; and
communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

2. The method of claim 1, further comprising:
receiving an update to the playlist file of the media stream;
identifying, within the media stream relative to the updated playlist file, a second advertisement content;
identifying, within the updated playlist file, a source location identifier of a segment corresponding to the second advertisement content;
identifying a second replacement advertisement content to replace the second advertisement content;
identifying a source location identifier corresponding to a segment of the second replacement advertisement content;
modifying in substantially real time the updated playlist file, the modifying the updated playlist file comprising replacing the source location identifier corresponding to the segments of the second advertisement content with the source location identifier corresponding to the segment of the second replacement advertisement content producing a modified updated playlist file; and
communicating in substantially real time, from the distribution service, the modified updated playlist file over the Internet to the remote CE device.

3. The method of claim 1, further comprising:
identifying, within the media stream, a second advertisement content;
wherein the modifying the playlist file further comprises maintaining a source location identifier corresponding to a segment of the second advertisement content within the modified playlist file such that the second advertisement content is not replaced.

4. The method of claim 1, wherein the identifying the first replacement advertising content to replace the first advertisement content comprises:
identifying one or more relevance parameters associated with the remote CE device, where the remote CE device is a targeted CE device intended to receive the modified playlist file;
parsing an advertisement pool based on the one or more relevance parameters, where the advertisement pool comprising information corresponding to a plurality of different potential advertisement content; and
identifying, in response to the parsing, a correlation of the one or more relevance parameters and information corresponding to the first replacement advertisement content of the information of the advertisement pool.

5. The method of claim 4, wherein the one or more relevance parameters comprises location information corresponding to a geographic location of the remote CE device within the world.

6. The method of claim 4, further comprising:
accessing a user profile corresponding to a user interacting with the targeted CE device, and wherein one or more relevance parameters are extracted from the profile information, and the extracted one or more relevance parameters comprise one or more of location information, user preference, viewing history, search history, and purchase history.

7. The method of claim 4, further comprising:
receiving, at the distribution service and from over a distributed network, the one or more relevance parameters from the targeted CE device.

8. A computer program product comprising a medium for embodying a computer program for input to a processor based system and a computer program embodied in the medium configured to cause the processor based system to perform steps comprising:
receiving, at a distribution service accessible by consumer electronic (CE) devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back;
identifying, within the media stream, a first advertisement content;
identifying, within the playlist file, one or more source location identifiers corresponding to one or more segments of the first advertisement content;
identifying a first replacement advertisement content to replace the first advertisement content;
identifying one or more source location identifiers corresponding to one or more segments of the first replacement advertisement content;
modifying in substantially real time the playlist file, the modifying comprising replacing each of the one or more source location identifiers corresponding to the segments of the first advertisement content defined within the media stream with the one or more source location identifiers corresponding to the one or more segments of the first replacement advertisement content producing a modified playlist file; and
communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

9. The computer program product in accordance with claim 8, further configured to cause the processor based system to perform steps comprising:
receiving an update to the playlist file of the media stream;
identifying, within the media stream relative to the updated playlist file, a second advertisement content;
identifying, within the updated playlist file, a source location identifier of a segment corresponding to the second advertisement content;
identifying a second replacement advertisement content to replace the second advertisement content;
identifying a source location identifier corresponding to a segment of the second replacement advertisement content;
modifying in substantially real time the updated playlist file, the modifying the updated playlist file comprising replacing the source location identifier corresponding to the segments of the second advertisement content with the source location identifier corresponding to the segment of the second replacement advertisement content producing a modified updated playlist file; and
communicating in substantially real time, from the distribution service, the modified updated playlist file over the Internet to the remote CE device.

10. The computer program product in accordance with claim 9, further configured to cause the processor based system to perform steps comprising:
identifying, within the media stream, a second advertisement content;
wherein the modifying the playlist file further comprises maintaining a source location identifier corresponding to a segment of the second advertisement content within the modified playlist file such that the second advertisement content is not replaced.

11. The computer program product in accordance with claim 8, wherein the identifying the first replacement advertising content to replace the first advertisement content comprises:
identifying one or more relevance parameters associated with the remote CE device, where the remote CE device a targeted CE device intended to receive the modified playlist file;
parsing an advertisement pool based on the one or more relevance parameters, where the advertisement pool comprising information corresponding to a plurality of different potential advertisement content; and
identifying, in response to the parsing, a correlation of the one or more relevance parameters and information corresponding to the first replacement advertisement content of the information of the advertisement pool.

12. The computer program product in accordance with claim 11, wherein the one or more relevance parameters comprises location information corresponding to a geographic location of the targeted CE device within the world.

13. The computer program product in accordance with claim 11, further configured to cause the processor based system to perform step comprising:
accessing a user profile corresponding to a user interacting with the targeted CE device, and wherein one or more relevance parameters are extracted from the profile information, and the extracted one or more relevance parameters comprise one or more of location information, user preference, viewing history, search history, and purchase history.

14. A system for use in distributing multimedia content, the system comprising:
means for receiving, at a distribution service accessible by consumer electronic (CE) devices via the Internet, a substantially live media stream, the media stream comprising visual multimedia content and a playlist file that defines the playback of the visual multimedia content, where the visual multimedia content is segmented into a plurality of segments, the plurality of segments comprise main program content segments and advertisement segments, and the playlist file comprises source location identifiers that are configured to be used by a CE device to acquire each of the main program content segments and the advertisement segments to be played back;
means for identifying, within the media stream, a first advertisement content;
means for identifying, within the playlist file, one or more source location identifiers corresponding to one or more segments of the first advertisement content;
means for identifying a first replacement advertisement content to replace the first advertisement content;
means for identifying one or more source location identifiers corresponding to one or more segments of the first replacement advertisement content;
means for modifying in substantially real time the playlist file by replacing each of the one or more source location identifiers corresponding to the segments of the first advertisement content defined within the media stream with the one or more source location identifiers corresponding to the one or more segments of the first replacement advertisement content producing a modified playlist file; and
means for communicating, in substantially real time from the distribution service, the modified playlist file over the Internet to a remote CE device, where the modified playlist file is configured to be utilized by the remote CE device in acquiring and playing back the segments of the main program content and the one or more segments of the first replacement advertisement content.

15. The system of claim 14, further comprising:
means for receiving an update to the playlist file of the media stream;
means for identifying, within the media stream relative to the updated playlist file, a second advertisement content;
means for identifying, within the updated playlist file, a source location identifier of a segment corresponding to the second advertisement content;
means for identifying a second replacement advertisement content to replace the second advertisement content;
means for identifying a source location identifier corresponding to a segment of the second replacement advertisement content;
means for modifying in substantially real time the updated playlist file, wherein the means for modifying the updated playlist file comprises means for replacing the source location identifier corresponding to the segment of the second advertisement content with the source location identifier corresponding to the segment of the second replacement advertisement content producing a modified updated playlist file; and
means for communicating in substantially real time, from the distribution service, the modified updated playlist file over the Internet to the remote CE device.

16. The system of claim 14, further comprising:
means for identifying, within the media stream, a second advertisement content;
wherein the means for modifying the playlist file further comprises means for maintaining a source location identifier corresponding to a segment of the second advertisement content within the modified playlist file such that the second advertisement content is not replaced.

17. The system of claim 14, wherein the means for identifying the first replacement advertising content to replace the first advertisement content comprises:
means for identifying one or more relevance parameters associated with the remote CE device, where the remote CE device is a targeted CE device intended to receive the modified playlist file;
means for parsing an advertisement pool based on the one or more relevance parameters, where the advertisement pool comprising information corresponding to a plurality of different potential advertisement content; and
means for identifying, in response to the parsing, a correlation of the one or more relevance parameters and information corresponding to the first replacement advertisement content of the information of the advertisement pool.

18. The method of claim 17, wherein the one or more relevance parameters comprises location information corresponding to a geographic location of the CE device within the world.

19. The system of claim 17, further comprising:
means for accessing a user profile corresponding to a user interacting with the targeted CE device, and wherein one or more relevance parameters are extracted from the profile information, and the extracted one or more relevance parameters comprise one or more of location information, user preference, viewing history, search history, and purchase history.
